(19) United States
(12) Patent Application Publication
(10) Pub. No.: US 2005/0120152 A1
(43) Pub. Date: Jun. 2, 2005

(54) Method for rendering two output formats simultaneously

(76) Inventor: Carolus De Bie, Turnhout (BE)

Correspondence Address: Robert A Sabourin;Agfa Corporation, Patent Department, 200 Ballardvale Street, Wilmington, MA, 01069, US

(21) Appl. No.: 10/505,322

(22) PCT Filed: Feb. 27, 2003
(86) PCT No.: PCT/EP03/50035

Related U.S. Application Data
(60) Provisional application No. 60/373,514, filed on Apr. 18, 2002.

(30) Foreign Application Priority Data
Feb. 28, 2002 (EP) 02100203.5

(51) Int. Cl. G06F 3/00

(52) U.S. Cl. 710/36

(57) ABSTRACT

A method for rendering input data simultaneously into output data (10) in a first output format and in a second output format, the method including: a) defining a plurality of bands (11-14) constituting the output data (10); and b) for each specific band (11-14) out of the plurality of bands (11-14): i) generating by a renderer from the input data first output data for the specific band (11-14) in the first output format, i) and generating, from the first output data, second output data for the specific band (11-14) in the second output format.

### FIELD OF THE INVENTION

The invention relates to printing images, in particular to rendering image data in order to print them.

### BACKGROUND OF THE INVENTION

In order to produce printed matter such as books, newspapers, packaging material and the like, the involved image data are usually processed by a pre-press workflow system. Such a pre-press workflow system is disclosed in patent application WO 01/25907. One of the steps in a pre-press process is the rendering process, i.e. the translation of the image data from page description languages like Postscript or PDF to raster data, which are also called bitmap data. The rendering process is performed by a renderer, also known as the Raster Image Processor or RIP. The input data of the renderer are the image data, the output data are the bitmap data. The output data of the renderer are sent to a device such as an imagesetter or a platesetter, which is called in this document the main output device. The output data of the renderer for the main output device are called in this document the main output data. In an imagesetter, by means of the bitmap data a radiation-sensitive film is exposed, that is used to obtain a printing plate. In a platesetter, the printing plate is obtained directly, by exposing a printing plate precursor by means of the bitmap data. The printing plate is then used, e.g. in an offset press, to produce the printed matter. Very often, prior to final output the data are checked by means of a proofing device (also called proofer). The proofing device requires data in another format, e.g. at a lower resolution, than the main output device.

U.S. Pat. No. 5,625,766 discloses a software based proofing method allowing to proof and measure registration between the front and the back side of a press sheet by displaying, on a color monitor, both sides superimposed on each other. The data to be displayed is taken from a low resolution raster image processor identical in operation to a full resolution raster image processor used to generate the output for the main output device.

In another prior art implementation, the main output data of the renderer is first stored on disk. In the usual case of color output, the color separation files are stored on a plane by plane basis; typically first the cyan separation is generated by the renderer and stored on disk, followed by magenta, yellow, black and optionally by spot colors. When requesting the proof, the main output data is read from disk (as mentioned, typically data for four color planes and for an additional plane per spot color), the color separations are recombined and the data for the proofing device is generated from the high resolution screened data intended for the main output device.

For more information on proofing, rendering, imposition and other relevant terms, we refer to U.S. Pat. No. 5,625,766 mentioned already above.

There is still a need for an improved method for rendering output data in two different formats from input data.

### SUMMARY OF THE INVENTION

The present invention is a method for generating output data in two different output formats as claimed in independent claim 1. The invention also includes a system and a computer program implementing the method. Preferred embodiments of the invention are set out in the dependent claims.

In a method in accordance with the invention, the two output formats are generated virtually simultaneously. The main output data has a format that is typically intended for high resolution, monochrome, binary marking engines, such as imagesetters and platesetters. It is typically 2400 dpi (dots per inch), color separated, screened output. The format of the generated auxiliary output data is typically used for proofers; it may be 720 dpi, contone, color managed, composite. Both formats are generated at the same time.

An advantage of the invention is that the performance of the system is significantly improved. This is especially important because formats of imaging devices are increasingly getting larger and larger. The invention allows to maintain acceptable throughputs on standard hardware, and to obtain higher throughputs on faster hardware.

Moreover, only one renderer is required, whereas the method disclosed in U.S. Pat. No. 5,625,766, mentioned above, requires two different renderers, a low resolution one and a full resolution one.

Preferably, the data for the proofing device are generated from the high resolution screened data intended for the main output device, by processing the screened data; this may involve descreening, zooming, color managing the screened data. This offers the advantage that the proofer data are completely consistent with the main output data.

Further advantages and embodiments of the present invention will become apparent from the following description and drawing.

### BRIEF DESCRIPTION OF THE DRAWINGS

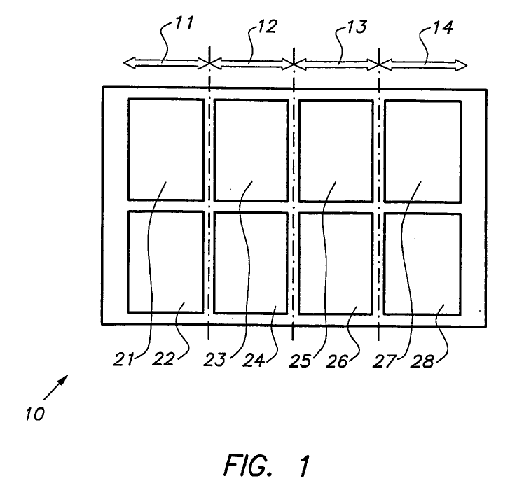

The invention is described with reference to FIG. 1, which is used to illustrate an embodiment in accordance with the invention.

### DETAILED DESCRIPTION OF THE INVENTION

In a preferred embodiment of the invention, the output data of the renderer is divided into a plurality of bands. This is illustrated by means of FIG. 1. FIG. 1 shows output page data 21-28 of eight pages that will be printed on a single sheet by an offset press. If e.g. a leaflet is printed, customarily several pages of the leaflet are printed on a single, large sheet and they are arranged, by a process called imposition, in such a way that after printing, folding and possibly cutting the order of the pages in the final product is correct. The single large sheet is, in imposition terminology, called the flat. The output data 10 that correspond to the flat can have a very large size, especially after the screening step. In the embodiment illustrated by means of FIG. 1, a plurality of bands 11-14 constitute the output data 10, in such a way that each band 11-14 contains output page data 21-28 of two adjoining pages, e.g. band 11 contains page data 21 and 22. In general, a band may cross page borders. Usually, a band will be much smaller than a page; the size of a band may be determined by the available amount of memory in the renderer. In general, a band 11-14 covers a subset of the output data 10, so that all output data 10 belong to exactly one of the bands 11-14 and so that the data of all bands 11-14 together constitute the output data. The output data can also be divided into a plurality of bands if no pages are used, such as for packaging applications where the output data contain basic data that are replicated via a so-called step-and repeat operation.

Preferably, the invention is implemented by means of a special mode in the renderer that allows for the generation of bands. E.g. the CPSI renderer from Adobe can be configured in such a way that, instead of generating, as is customary, a whole color separation, color per color, the output data are generated for a first band for all different colors, then for a second band for all different colors, and so on; the band size can also be configured. A particular embodiment of the invention for color output is as follows. Initially, a first band of cyan is generated, followed by a first band of magenta, a first band of yellow, a first band of black, and optionally first bands for each separated spot color. After all the separations for the first band are generated in memory, the proofing processing (recombination, descreening, etc.) starts working on the first band and may store the processed proofing data on disk, or, alternatively, send it immediately to the proofer. Then, the process is repeated to generate a second band, and so on until all data are generated.

Preferably, the output data as generated by the renderer for the successive bands are appended to each other, for each color, and the appended data are sent to the main output device, so that the main output device receives a set of appended data for each color.

It is preferred that the data in the second output format, intended e.g. for a proofing device, are generated from the data in the first output format for the main output device, band per band; this can be performed in different ways. In a first embodiment, generating the data in the second output format includes resampling the data in the first output format, as described e.g. in EP-A-1 139 654. In a second embodiment, generating the data in the second output format includes descreening the data in the first output format, i.e. the binary, screened data in the first output format are converted to a contone value. This can be illustrated by the following very simple example, wherein the data in the first output format are 2400 dpi and those in the second format 600 dpi. The 2400 dpi binary data are divided in squares of sixteen bits, i.e. 4×4 bits. Suppose that in a square of 4×4 bits four bits are set, i.e. have a value 1, and twelve bits are zero. The contone value for this square is then 256*4/16=64=(40)_{HEX} in hexadecimal. This is then repeated for the next square of 4×4 bits.

Possibly, an additional action is performed in the border area between a first band and a second band, adjoining to the first one, in order to ensure a correct transition between both bands for the data in the second output format. Data in the first output format for the border area may then be stored, preferably in memory, to calculate the data in the second output format in the border area. In the very simple example discussed above, if the border between the first and the second band does not coincide with sides of the 4×4 squares (but divides e.g. those squares in halves), then, when processing the first band, the data in the first output format of those squares on the border may be stored temporarily, and used subsequently in calculating the data in the second output format for the second band.

The data in the second output format may directly be sent to the proofer, e.g. band per band, or they may be stored, e.g. on disk.

The invention is not limited to the embodiments described above. In case of color output, other colors may be used; the order of the colors may arbitrary. The invention is also applicable to black-and-white output. The invention may also be applied to other devices than a main output device and a proofer.

Having described in detail preferred embodiments of the current invention, it will now be apparent to those skilled in the art that numerous modifications can be made therein without departing from the scope of the invention as defined in the appending claims.

List of Reference Signs

10: output data
11: band
12: band
13: band
14: band
21: page data
22: page data
23: page data
24: page data
25: page data
26: page data
27: page data
28: page data

1. A method for rendering input data simultaneously into output data in a first output format and in a second output format, the method comprising the steps of:
defining a plurality of bands constituting said output data;
for each specific band out of said plurality of bands:
i) generating by a renderer from said input data first output data for said specific band in said first output format;
ii) generating, from said first output data, second output data for said specific band in said second output format
sending said output data in said first output format to a main output device; and
sending said output data in said second output format to a proofing device.

2. (canceled)

3. The method according to claim 2 wherein said main output device is either an imagesetter or a platesetter.

4. The method of claim 1 wherein said first output data for said specific band comprises data for a plurality of colors.

5. The method according to claim 1 further comprising the step of:
descreening said first output data for said specific band.

6. The method according to claim 1 further comprising the steps of:
temporarily storing a first portion of said first output data for said specific band wherein said first portion adjoins data for another specific band out of said plurality of bands;
using said first portion of said first output data for said specific band for connecting said second output data for said specific band to said second output data for said other specific band.

7. The method according to claim 1 further comprising the step of:
appending said first output data for each specific band out of said plurality of bands, thus obtaining said output data in said first output format.

8. A system for processing data comprising:
means for defining a plurality of bands constituting said output data;
for each specific band out of said plurality of bands:
i) means for generating by a renderer from said input data first output data for said specific band in said first output format;
ii) means for generating, from said first output data, second output data for said specific band in said second output format
means for sending said output data in said first output format to a main output device; and
means for sending said output data in said second output format to a proofing device.

9. The system according to claim 8 further comprising said wherein said main output device is an imagesetter, a platesetter or a proofing device.

10. (canceled)

11. A computer program running on a computer for rendering input data simultaneously into output data in a first output format and in a second output format, the computer program comprising:
defining a plurality of bands constituting said output data;
for each specific band out of said plurality of bands:
i) generating by a renderer from said input data first output data for said specific band in said first output format;
ii) generating, from said first output data, second output data for said specific band in said second output format;
sending said output data in said first output format to a main output device; and
sending said output data in said second output format to a proofing device.

12. A computer readable medium comprising program code when run on a computer for rendering input data simultaneously into output data in a first output format and in a second output format, for:
defining a plurality of bands constituting said output data;
for each specific band out of said plurality of bands:
i) generating by a renderer from said input data first output data for said specific band in said first output format;
ii) generating, from said first output data, second output data for said specific band in said second output format;
sending said output data in said first output format to a main output device; and sending said output data in said second output format to a proofing device.

13. The computer program of claim 11 wherein the step of sending said output data in said first output format to a main output device comprises sending said output data to an imagesetter, a platesetter or a proofing device.

14. A computer program product for rendering input data simultaneously into output data in a first output format and in a second output format, the computer program product comprising:
first program instructions for defining a plurality of bands constituting said output data;
second program instructions for, for each specific band out of said plurality of bands:
i) generating by a renderer from said input data first output data for said specific band in said first output format; and
ii) generating, from said first output data, second output data for said specific band in said second output format;
third program instructions for sending said output data in said first output format to a main output device; and
fourth program instructions for sending said output data in said second output format to a proofing device.

15. The computer program product according to claim 14 further comprising a computer readable medium wherein said first, second, third and fourth program instructions are recorded on said medium.

16. The computer program product according to claim 14 wherein said main output device is an imagesetter or a platesetter.

17. The computer program product according to claim 14 wherein said first output data for said specific band comprise data for a plurality of colors.

18. The computer program according to claim 14 further comprising:
fifth program instructions for temporarily storing a first portion of said first output data for said specific band wherein said first portion adjoins data for another specific band out of said plurality of bands; and
sixth program instructions for using said first portion of said first output data for said specific band for connecting said second output data for said specific band to said second output data for said other specific band.
